(19) United States
(12) Patent Application Publication
(10) Pub. No.: US 2022/0033578 A1
(43) Pub. Date: Feb. 3, 2022

(54) FLUOROELASTOMER COMPOSITION

(71) Applicant: SOLVAY SPECIALTY POLYMERS ITALY S.P.A., Bollate (IT)

(72) Inventors: Ritu AHUJA, Singapore (SG); Debaki GHOSH, Gujarat (IN); Kamini SHARMA, Vadodara (IN); Letanzio BRAGANTE, Due Carrare (IT); Stefano MILLEFANTI, Tradate (IT)

(21) Appl. No.: 17/280,321

(22) PCT Filed: Sep. 27, 2019
(86) PCT No.: PCT/EP2019/076144

§ 371 Date: Mar. 26, 2021

(30) Foreign Application Priority Data
Oct. 1, 2018 (IN) 201821037162
Nov. 28, 2018 (EP) 18208772.6

(51) Int. Cl. C08G 65/00; C08K 5/18

(52) U.S. Cl. CPC C08G 65/007; C08G 2650/48; C08K 5/18

(57) ABSTRACT

The invention pertains to a fluoroelastomer composition including at least a nitrile-containing (per)fluoropolyether compound and at least one bis-amino(thio)phenol compound of formula (I), wherein: A is —SO₂—, —O—, —C(O)— or divalent hydrocarbon groups of 1 to 10 carbon atoms, E is independently oxygen or sulphur and —NH2 groups are in ortho with respect to EH groups; to a process for manufacturing a (per)fluoropolyether-based thermoset and to a (per)fluoropolyether-based thermoset obtained therefrom.

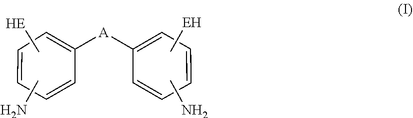

### CROSS REFERENCE TO RELATED APPLICATIONS

This application claims priority to Indian provisional patent application No. 201821037162 filed on Oct. 1, 2018 and to European patent application No. 18208772.6 filed on Nov. 28, 2018, the whole content of each of these applications being incorporated herein by reference for all purposes.

### TECHNICAL FIELD

The invention pertains to a fluoroelastomer composition, to a process for manufacturing a (per)fluoropolyether-based thermoset starting from said fluoroelastomer composition, and to a (per)fluoropolyether-based thermoset obtained with said process and having improved elongation and thermal stability.

### BACKGROUND ART

Fluoroelastomers, and more specifically perfluoroelastomers, have long been used in a variety of applications that require excellent resistance to high temperature and chemical attack, such as in the automotive and aircraft industry where resistance to fuel is desired.

Fluoroelastomers can be prepared by curing fluoroelastomer polymer chains, i.e. by chains cross-linking. To enable cross-linking, it has long been known to incorporate in the fluoroelastomer polymer chains a small percentage of monomers including nitrile groups, whose reactivity in the presence of a variety of curing agents is such to provide cross-linking points of supposedly triazine-type or similar structure, which has high thermal stability. Said curing agents include for example aromatic tetra-amines, di(amino(thio)phenols), and organo-tin compounds, including tetraalkyl and tetraaryl compounds.

In this field, U.S. Pat. No. 4,525,539 discloses perfluoroelastomer compositions comprising a nitrile-containing perfluoroelastomer polymer and a vulcanizing agent for that polymer, wherein the perfluoroelastomer polymer is a copolymer of tetrafluoroethylene (TFE), perfluoromethyl perfluorovinyl ether (PMVE) and a cure-site nitrile-containing monomer, and the vulcanizing agent may be selected among bis(aminophenols).

Similarly, U.S. Pat. No. 5,677,389 discloses curable compositions comprising a nitrile-containing perfluoroelastomer copolymer and a curing agent selected among bis(aminophenols). Said compositions also comprise an ammonium salt.

US 2012/009438 discloses a curable fluoroelastomer composition comprising: i) a fluoroelastomer comprising nitrile groups, and ii) a (per)fluoropolyether comprising repeating units selected from (—C₄F₈O—), (—C₂F₄O—) or (—CF₂O—), or a combination thereof, and further containing nitrile groups, which react with the fluoroelastomer to yield a triazine unit. The composition generally further includes a curing agent comprising amine, amidine, imidate, amidoxime, amidrazone groups. U.S. Pat. No. 5,545,693 discloses a similar composition.

U.S. Pat. No. 9,290,619 discloses curing a nitrile-containing perfluoropolyether with a curing agent selected from aliphatic, aromatic, heterocyclic or alicyclic primary or secondary amines, diamines or polyamines, thus obtaining triazine-containing fluoropolyether polymers. However, said polymers do not show good elastomeric properties and possess, for example, low elongation at break.

U.S. Pat. No. 3,810,874 discloses curing an ester- or acyl halide-containing perfluoropolyethers with ortho-aminophenols, thus yielding benzoxazole-containing perfluoropolyether polymers, which however are not shown to possess elastomeric properties.

The need is therefore felt to provide curable (per)fluoroelastomer compositions able to deliver, upon curing, higher flexibility, better mechanical properties and improved resistance to high temperature and chemical attack.

### SUMMARY OF INVENTION

The aim of the present invention is to provide a (per)fluoroelastomer composition which is, upon curing, resistant to heat and chemical attack, has high elongation at break, good mechanical properties and wide range of applicability.

In a first aspect, the present invention relates to a (per)fluoroelastomer composition [composition (C)] comprising:
a) at least one (per)fluoropolyether compound comprising a plurality of nitrile groups [compound (CN-PFPE)], and
b) at least one bis-amino(thio)phenol compound [compound (AP)] of formula (I):

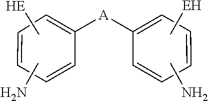

wherein:
A is selected among: —SO₂—, —O—, —C(O)—, divalent hydrocarbon groups of 1 to 10 carbon atoms, said hydrocarbon groups being preferably partially or totally fluorinated;
each of E, equal or different at each occurrence, is oxygen or sulphur, preferably oxygen, and
—NH₂ groups and EH groups are interchangeably in ortho, meta or para positions with respect to the group A, and
—NH₂ groups are in ortho with respect to EH groups.

In a second aspect, the present invention relates to a process for the manufacture of a (per)fluoropolyether-based thermoset comprising:
a) mixing at least one (per)fluoropolyether compound comprising a plurality of nitrile groups [compound (CN-PFPE)] with at least one bis-amino(thio)phenol compound [compound (AP)] of formula (I):

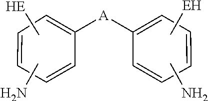

thus obtaining a (per)fluoroelastomer composition [composition (C)], wherein:
A is selected among: —SO₂—, —O—, —C(O)—, divalent hydrocarbon groups of 1 to 10 carbon atoms, said hydrocarbon groups being preferably partially or totally fluorinated;
each of E, equal or different at each occurrence, is oxygen or sulphur, preferably oxygen,
—NH₂ groups and EH groups are interchangeably in ortho, meta or para positions with respect to the group A, and
—NH₂ groups are in ortho with respect to EH groups;
b) heating said composition (C) to a temperature of at least 30° C., so as to obtain the (per)fluoropolyether-based thermoset.

In a third aspect, the present invention relates to a (per)fluoropolyether-based thermoset obtained with the above process.

The Applicant has surprisingly found that said (per)fluoropolyether-based thermoset has excellent chemical and thermal stability in various harsh environments combined with good weathering resistance, low surface tension, hydrophobicity and oleophobicity. The (per)fluoropolyether-based thermoset of the invention advantageously has a low glass transition temperature (T_{g}), which makes it applicable even at low temperature. In addition, the (per)fluoropolyether-based thermoset of the invention surprisingly shows enhanced elastomeric properties, a very high elongation at break and excellent mechanical properties, which render said thermoset particularly useful in sealing applications.

### DETAILED DESCRIPTION OF THE INVENTION

In the present description, unless otherwise indicated, the following terms are to be meant as follows.

The expression “divalent hydrocarbon group” is to be understood as a divalent radical derived from a hydrocarbon by removal of two atoms of hydrogen from carbon atoms; a divalent hydrocarbon group thus comprises two ends, each end being able to form a linkage with another chemical group.

The term “(per)fluoropolyethers” is intended to indicate fully or partially fluorinated polyether polymers, which can be linear polymers, i.e. with a linear backbone chain, or branched polymers, i.e. further comprising side chains.

The “backbone chain” is the longest series of covalently bonded atoms that together create a continuous chain of the molecule.

The expression “terminal position” as used herein encompasses the terminal position of the backbone chain and the terminal position of a side chain in case of branched polymers.

The expression “inert atmosphere” is intended to indicate an atmosphere with substantially no oxygen.

In the present description, the use of parentheses “( . . . )” before and after the names of compounds, symbols or numbers identifying formulae or parts of formulae like, for example, “composition (C)”, “compound (CN-PFPE)” and “compound (AP)”, has the mere purpose of better distinguishing those names, symbols or numbers from the remaining text; thus, said parentheses could also be omitted.

### Compound (AP)

As said, the composition (C) comprises at least one bis-amino(thio)phenol compound [compound (AP)] of formula (I) as above detailed.

A is preferably a divalent hydrocarbon group, more preferably a totally fluorinated divalent hydrocarbon group. A is preferably hexafluoropropylidene.

According to a preferred embodiment, said compound (AP) is 2,2-bis(3-amino-4-hydroxyphenyl)hexafluoropropane (BOAP), having formula:

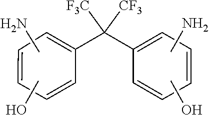

The amount of compound (AP) in composition (C) preferably ranges from 0.2 to 50% (wt), more preferably from 1 to 40% (wt).

### Compound (CN-PFPE)

As said, the composition (C) comprises a (per)fluoropolyether compound comprising a plurality of nitrile groups [compound (CN-PFPE)]. According to various embodiments, said compound (CN-PFPE) may be linear or branched, as defined above.

Said compound (CN-PFPE) comprises a (per)fluoropolyoxyalkylene backbone chain [chain (R_{f})] and, optionally, one or more (per)fluoropolyoxyalkylene side chains [chain(s) (R_{fs})]. According to various embodiments, one or more nitrile groups of said plurality are pendant groups from at least one of said chain (R_{f}) and chain(s) (R_{fs}), and/or are positioned at a terminal position of one or more of said chain (R_{f}) and chain(s) (R_{fs}) or at a position adjacent to said terminal position.

The amount of compound (CN-PFPE) in composition (C) preferably ranges from 50 to 99.8% (wt), more preferably from 60 to 99% (wt).

### First Embodiment

According to a first embodiment of the invention, the nitrile groups are pendant groups from the (per)fluoropolyoxyalkylene backbone chain (R_{f}) and/or from at least one (per)fluoropolyoxyalkylene side chain (R_{fs}), if one or more chains (R_{fs}) are present, namely if the compound (CN-PFPE) is branched. Accordingly, said compound (CN-PFPE) is a copolymer comprising copolymerized units of a monomer having at least one nitrile group.

In a specific embodiment, said compound (CN-PFPE) has formula (II):

T^{A}-O—R_{f}¹-T^{A′} (II)

wherein:

R_{f}¹ is a (per)fluoropolyoxyalkylene backbone chain with formula [R_{f}²—O]ₙ₁[R_{f}³—O]ₙ₂, wherein:

each of R_{f}², equal to or different from each other at each occurrence, is a (per)fluoroalkylene group,

each of R_{f}³, equal to or different from each other at each occurrence, is a (per)fluoroalkylene group comprising at least one nitrile group, and

n₁ and n₂ are integers different from zero,

and wherein T^{A} and T^{A′}, equal to or different from each other, are groups of formula Y—CF₂—, wherein Y is selected from the group consisting of F, Cl, and a C₁-C₃ perfluoroalkyl group, said perfluoroalkyl group being preferably CF₃.

Preferably, repeating units —R_{f}³—O— of the compound (CN-PFPE) of formula (II) are selected from the group consisting of:

(a2) units —CF₂CF(Gₓ)O—

(b2) units CF(Gₓ)O—

(c2) units —CF₂(CF₂)ₓ₁CF(Gₓ)(CF₂)ₓ₂O—, with X₁ and X₂ being zero or integers from 1 to 2, with the provision that X₁+X₂ is at least 1, wherein: Gₓ is a C₁-05 perfluoro(oxy)alkylene group comprising at least one nitrile group.

Compounds (CN-PFPE) according to said first embodiment can be manufactured notably using the methods described in EP 244 839 (AUSIMONT SPA) and U.S. Pat. No. 4,384,128 (DU PONT).

### Second Embodiment

According to a second embodiment of the invention, at least one nitrile group is positioned at a terminal position of the (per)fluoropolyoxyalkylene backbone chain (R_{f}) or a (per)fluoropolyoxyalkylene side chain (R_{fs}), if one or more chains (R_{fs}) are present, namely if the compound (CN-PFPE) is branched. Alternatively, said at least one nitrile group may be positioned in a position adjacent to said terminal position. For the sake of brevity, said at least one nitrile group will be also referred to below as “terminal nitrile group”.

Preferably, said compound (CN-PFPE) contains a plurality of terminal nitrile groups, said terminal nitrile groups being positioned at terminal positions of the (per)fluoropolyoxyalkylene backbone chain (R_{f}) and/or of at least one (per)fluoropolyoxyalkylene side chain (R_{fs}), if one or more chains (R_{fs}) are present, namely if the compound (CN-PFPE) is branched.

In a specific embodiment, said compound (CN-PFPE) contains two terminal nitrile groups. In a more specific embodiment, said terminal nitrile groups are positioned at the terminal positions of the (per)fluoropolyoxyalkylene backbone chain (R_{f}).

Preferably, the nitrile groups of the compound (CN-PFPE) are exclusively terminal nitrile groups, meaning that there are no nitrile groups pending from the chain (R_{f}) and/or the chain(s) (R_{fs}).

More preferably, the compound (CN-PFPE) has formula (III):

T^{B}-O—R_{f}⁴-T^{B′} (III)

wherein:

R_{f}⁴ is a (per)fluoropolyoxyalkylene backbone chain [chain (R_{f}⁴)], and

T^{B} and T^{B′}, equal to or different from each other, are (hydro)(fluoro)carbon groups, optionally comprising ethereal oxygen atom(s), and comprising a nitrile group at a terminal position or at a position adjacent to the terminal position.

Preferably, T^{B} and T^{B′} are independently selected from groups of formula: —CFZ*—CN, —CFZ*CH₂—CN, and —CFZ*CH₂—(OCH₂CH₂)ₖ—CN, wherein k ranges from 0 to 10 and Z* is F or CF₃. More preferably, T^{B} and T^{B′} are groups of formula —CFZ*—CN, wherein Z* is as defined above.

The compound of formula (III) may be provided, as a consequence of its synthetic method and precursors used, as a mixture comprising variable fractions of: molecules wherein both T^{B} and T^{B′} are (hydro)(fluoro)carbon groups comprising a nitrile group (also referred to as difunctional molecules); molecules wherein only one of T^{B} and T^{B′} is a (hydro)(fluoro)carbon group comprising a nitrile group while the other one is a (hydro)(fluoro)carbon group free from nitrile groups (also referred to as monofunctional molecules), and molecules wherein both T^{B} and T^{B′} are (hydro)(fluoro)carbon groups free from nitrile groups (also referred to as non-functional molecules). The (hydro)(fluoro)carbon groups free from nitrile groups are generally selected from C₁-C₂₄ (hydro)(fluoro)carbon groups, possibly comprising one or more than one of H, O, and Cl.

The best results have been achieved when the compound of formula (III) was provided as an admixture mainly consisting of difunctional molecules.

When the compound of formula (III) is provided as an admixture of difunctional, monofunctional and non-functional molecules, the amounts of said molecules are generally such that at least 60% (mol), preferably at least 65% (mol), more preferably at least 70% of T^{B} and T^{B′} groups comprise a nitrile group.

Preferably, said chain (R_{f}⁴) comprises, preferably consists of, repeating units independently selected from the group consisting of:

(i) —CFXO—, wherein X is F or CF₃;

(ii) —CFXCFXO—, wherein X, equal or different at each occurrence, is F or CF₃, with the proviso that at least one of X is F;

(iii) —CF₂CF₂CW₂O—, wherein each of W, equal or different from each other, are F, Cl, H;

(iv) —CF₂CF₂CF₂CF₂O—;

(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of X being independently F or CF₃ and T being a C₁-C₃ perfluoroalkyl group.

Preferably, said chain (R_{f}⁴) complies with the following formula:

—[(CFX¹O)_{g1}(CFX²CFX³O)_{g2}(CF₂CF₂CF₂O)_{g3}(CF₂CF₂CF₂CF₂O)_{g4}]— (R_{f}⁴-I)
wherein
   X¹ is independently selected from —F and —CF₃,
   X², X³, equal or different from each other and at each occurrence, are independently —F, —CF₃, with the proviso that at least one of X is —F;
   g1, g2, g3, and g4, equal or different from each other, are independently integers ≥0, such that g1+g2+g3+g4 is in the range from 2 to 300, preferably from 2 to 100; should at least two of g1, g2, g3 and g4 be different from zero.

More preferably, said chain (R_{f}⁴) is selected from chains of formula:

—[(CF₂CF₂O)ₐ₁(CF₂O)ₐ₂]— (R_{f}⁴-IIA)
wherein:
   a1 and a2 are independently integers 0 such that the number average molecular weight is between 400 and 10,000, preferably between 1,000 and 8,000; both a1 and a2 are preferably different from zero, with the ratio a1/a2 being preferably comprised between 0.1 and 10;

—[(CF₂CF₂CF₂O)_{b}]— (R_{f}⁴-IIB)
wherein:
   b is an integer >0 such that the number average molecular weight is between 400 and 10,000, preferably between 1,000 and 8,000;

—[(CF₂CF₂CF₂CF₂O)_{c}]— (R_{f}⁴-IIC)
wherein:
   c is an integer >0 such that the number average molecular weight is between 400 and 10,000, preferably between 1,000 and 8,000;

—[(CF₂CF₂O)_{d1}(CF₂O)_{d2}(CF(CF₃)O)_{d3}(CF₂CF(CF₃)O)_{d4}]— (R_{f}⁴-IID)
wherein:
d1, d2, d3, d4, are independently integers 0 such that the number average molecular weight is between 400 and 10,000, preferably between 1,000 and 8,000; preferably d1 is 0, d2, d3, d4 are >0, with the ratio d4/(d2+d3) being ≥1;

—[(CF₂CF₂O)ₑ₁(CF₂O)ₑ₂(CF₂(CF₂)_{ew}CF₂))ₑ₃]— (R_{f}⁴-IIE)
wherein:
ew=1 or 2;
e1, e2, and e3 are independently integers 0 chosen so that the number average molecular weight is between 400 and 10,000, preferably between 1,000 and 8,000; preferably e1, e2 and e3 are all >0, with the ratio e3/(e1+e2) being generally lower than 0.2;

—[(CF(CF₃)CF₂O)_{f}]— (R_{f}⁴-IIF)

wherein:

f is an integer >0 such that the number average molecular weight is between 400 and 10,000, preferably between 1,000 and 8,000.

Chains (R_{f}⁴-IIA), (R_{f}⁴-IIB), (R_{f}⁴-IIC) and (R_{f}⁴-IIE) are particularly preferred.

Still more preferably, chain (R_{f}⁴) complies with formula (R_{f}⁴-IIA), wherein:
a1, and a2 are integers >0 such that the number average molecular weight is between 400 and 10,000, preferably between 1,000 and 8,000, with the ratio a1/a2 being generally comprised between 0.1 and 10, more preferably between 0.2 and 5.

### Third Embodiment

According to a third embodiment of the invention, said plurality of nitrile groups comprises at least one terminal nitrile group, as defined above, and at least one pendant nitrile group from the (per)fluoropolyoxyalkylene backbone chain (R_{f}) or (per)fluoropolyoxyalkylene side chain (R_{fs}), if one or more chains (R_{fs}) are present, namely if the compound (CN-PFPE) is branched.

As said, the present invention also pertains to a process for the manufacture of a (per)fluoropolyether-based thermoset.

The above mentioned step b) comprises heating said composition (C) to a temperature preferably ranging from 30 to 300° C., more preferably ranging from 50 to 300° C., for a time preferably ranging from 0.1 to 200 hours, more preferably ranging from 24 to 175 hours. The choice of temperature and time strongly depends on the number average molecular weight (Mn) of the compound (CN-PFPE), as will be more evident from the examples below. Preferably, said step b) comprises a plurality of sub-steps performed under inert atmosphere, preferably under nitrogen.

Yet, the invention pertains to a (per)fluoropolyether-based thermoset obtained by the above process.

Should the disclosure of any patents, patent applications and publications which are incorporated herein by reference conflict with the description of the present application to the extent that it may render a term unclear, the present description shall take precedence.

The present invention is described in more detail with reference to the following experimental section, whose purpose is merely illustrative and not limitative of the scope of the invention.

### Experimental Section

Materials

PFPE ZCY: mixture of compounds comprising a majority of NC—CF₂O—(CF₂CF₂O)ₘ(CF₂O)ₙ—CF₂CN (with m, n being integers such that a) Mn=1794 g/mol, Ew=1114 g/eq, and b) Mn=3949, Ew=2170, etc.) is synthesized according to the procedure disclosed for example in U.S. Pat. Nos. 5,545,693, 3,810,874 and WO 2012/138457.

PFPE Z-DEAL: mixture of compounds comprising a majority of CH₃CH₂O(O)C—CF₂—(CF₂CF₂O)ₘ(CF₂O)ₙ—CF₂C(O)CH₂CH₃ (with m, n being integers such that Mn=1669 g/mol and Ew=937 g/eq) is available from Solvay Specialty Polymers S.p.A.

BOAP: 2,2-bis(3-amino-4-hydroxyphenyl)hexafluoropropane was purchased from Sigma Aldrich.

Methods

Compression Set

The compression set of the (per)fluoropolyether elastomers was tested according to ASTM D395 (piled disk method).

Tensile Measurements

Tensile measurements were performed according to ASTM DIN53504 Type S2 or D638 Type 5.

Thermal Stability

Thermal stability tests were performed by dynamic TGA and isothermal TGA under flow of nitrogen.

### SYNTHESIS EXAMPLES

### Example 1

PFPE ZCY (20.0 g, 17.8 meq, Mn=1794 g/mol) and BOAP (2.957 g, 16.1 meq) were mixed by a speed mixer at room temperature. The so obtained mixture was then stirred at 100° C. by a mechanical stirrer for one hour. The temperature was subsequently raised to 170° C. and the mixture further stirred for 5 hours, thus obtaining a viscous reaction mass. The latter was transferred into a glass petri dish and kept under nitrogen for curing. The curing protocol was the following: 170° C. for 24 hours, 200° C. for 60 hours, 250° C. for 16 hours. A transparent light brown elastomeric film was obtained with a thickness of 1.13±0.15 mm.

### Example 2

PFPE ZCY (20.0 g, 17.8 meq, Mn=1794 g/mol) and BOAP (3.26 g, 17.8 meq) were mixed by a speed mixer at room temperature. The so obtained mixture was then stirred at 100° C. by a mechanical stirrer for one hour. The temperature was subsequently raised to 170° C. and the mixture further stirred for 5 hours, thus obtaining a viscous reaction mass. The latter was transferred into a glass petri dish and kept under nitrogen for curing. The curing protocol was the following: 170° C. for 24 hours, 200° C. for 60 hours, 250° C. for 16 hours. A transparent light brown elastomeric film was obtained with a thickness of 0.88±0.13 mm.

### Example 3

PFPE ZCY (20.0 g, 9.2 meq, Mn=3949 g/mol) and BOAP (0.51 g, 2.76 meq) were mixed by a speed mixer at room temperature. The so obtained mixture was then stirred at 100° C. by a mechanical stirrer for five hour, thus obtaining a viscous reaction mass. The latter was transferred into a glass petri dish and kept under nitrogen for curing. The curing protocol was the following: 100° C. for 24 hours, 130° C. for 8 hours, 150° C. for 17 hours, 150° C. to 250° C. for 76 hours, 300° C. for 2 hours. A transparent light brown elastomeric film was obtained with a thickness of 0.9±0.18 mm.

### Example 4 of Comparison

BOAP (17.7 g, 96.6 meq,) was added in a glass bottle to PFPE Z-DEAL (90.4 g, 96.5 meq). The resulting mixture was stirred vigorously for 30 minutes and then transferred into a 100 ml glass flask equipped with a stirrer, a water recirculating reflux condenser and a heating oil bath. The mixture was then stirred at 100° C. for one hour and subsequently at 170° C. for 5 hours. The so obtained mixture was split into two portions, which were poured into two glass petri dishes and treated in oven under nitrogen with the following protocol: 170° C. for 24 hours, 200° C. for 60 hours, 250° C. for 16 hours. Two black, rigid and brittle films (A) and (B) were obtained with thicknesses of 0.70±0.07 mm and 0.35±0.03 mm, respectively.

Thermal and Mechanical Characterization

Table 1 reports the weight losses (%) of the elastomeric films according to the examples 1 to 3 resulting from dynamic TGA and isothermal TGA.

Table 2 reports the thicknesses of the elastomeric films of the Ex. 1 to 3 and of the films (A) and (B) of comparative Ex. 4. Table 2 also reports the mechanical properties of said films, namely the strain at break, the stress at break, the tensile modulus and the compression set.

TABLE 1

| | Example 1 | Example 2 | Example 3 |
|---|---|---|---|
| Weight loss (% wt) | 1% (343° C.) | 1% (352° C.) | 1% (338° C.) |
| dynamic TGA | 5% (426° C.) | 5% (415° C.) | 5% (435° C.) |
| | 10% (460° C.) | 10% (457° C.) | 10% (475° C.) |
| Weight loss (% wt) | <0.7% (250° C., 1 h) | <0.3% (250° C., 1 h) | <1.0% (250° C., 1 h) |
| isothermal TGA | <5% (290° C., 1 h) | <1% (290° C., 1 h) | <2% (290° C., 1 h) |

TABLE 2

| | | | | Ex. 4C - | Ex. 4C - |
|---|---|---|---|---|---|
| | Ex. 1 | Ex. 2 | Ex. 3 | Film (A) | Film (B) |
| Thickness | 1.13 ± 0.15 | 0.88 ± 0.13 | 0.9 ± | 0.70 ± | 0.35 ± |
| [mm] | | | 0.18 | 0.07 | 0.03 |
| Strain at | 300 ± 23 | 177 ± 11 | 177 ± | 7.1 ± | 5.1 ± |
| break [%] | | | 36 | 2.5 | 1.9 |
| Stress at break | <0.5 | <0.5 | <0.5 | 5.2 ± | 7.1 ± |
| [MPa] | | | | 1.7 | 1.0 |
| Modulus | <1 | <1 | <1 | 167 ± 23 | 200 |
| [MPa] | | | | | |
| C-set at 23° C./ | ≅0/50 | ≅0/30 | ≅0/51 | — | — |
| 200° C. | | | | | |

As evident from Table 1, the (per)fluoropolyether-based thermosets according to Ex. 1 to 3 have a good thermal stability.

The data reported in Table 2 clearly demonstrate that films of Ex. 1 to 3 show a much higher strain (or elongation) at break, which means that they are flexible and elastic, while the films (A) and (B) of Ex. 4C are not. Furthermore, the films of Ex. 1 to 3 have lower values of stress at break with respect to the films (A) and (B) of Ex. 4C, which means that the films of Ex. 1 to 3 require lower stresses to induce elastic deformation than the films of Ex. 4C. Accordingly, the films of Ex. 1 to 3 have lower tensile modulus than the films (A) and (B) of Ex. 4C, namely they have lower resistance to elastic deformation.

Therefore, as evident from Tables 2 and 3, the films of Ex. 1 to 3 have enhanced elastomeric properties. On the contrary, the films (A) and (B) from Ex. 4C do not show elastomeric properties.

Said properties make the cured materials according to the invention suitable for different applications, such as sealings, coatings, encapsulations, heat sensitive packaging components.

1-15. (canceled)

16) A (per)fluoroelastomer composition [composition (C)] comprising:
a) at least one (per)fluoropolyether compound comprising a plurality of nitrile groups [compound (CN-PFPE)];
b) at least one bis-amino(thio)phenol compound [compound (AP)] of formula: 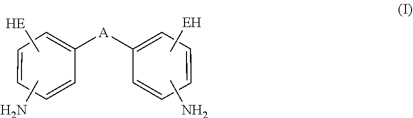
wherein:
A is selected among: —SO₂—, —O—, —C(O)—, divalent hydrocarbon groups of 1 to 10 carbon atoms, said hydrocarbon groups;
each of E, equal or different at each occurrence, is oxygen or sulphur;
—NH₂ groups and EH groups are interchangeably in ortho, meta or para positions with respect to the group A, and
—NH₂ groups are in ortho with respect to EH groups.

17) The composition according to claim 16, wherein A is hexafluoropropylidene.

18) The composition according to claim 16, wherein:
said compound (CN-PFPE) comprises a (per)fluoropolyether backbone chain [chain (R_{f})] and, optionally, one or more (per)fluoropolyether side chains [chain(s) (R_{fs})], and
one or more nitrile groups of said plurality are pendant groups from at least one of said chain (R_{f}) and chain(s) (R_{fs}), and/or are positioned at a terminal position of one or more of said chain (R_{f}) and chain(s) (R_{fs}) or at a position adjacent to said terminal position.

19) The composition according to claim 18, wherein said compound (CN-PFPE) has formula (II):
T^{A}-O—R_{f}¹-T^{A′} (II)
wherein:
R_{f}¹ is a (per)fluoropolyoxyalkylene backbone chain with formula [R_{f}²—O]ₙ₁[R_{f}³—O]ₙ₂,
wherein:
each of R_{f}², equal to or different from each other at each occurrence, is a (per)fluoroalkylene group;
each of R_{f}³, equal to or different from each other at each occurrence, is a (per)fluoroalkylene group comprising at least one nitrile group;
n1 and n2 are integers different from zero,
T^{A} and T^{A′}, equal to or different from each other, are groups of formula Y—CF₂—, wherein
Y is selected from the group consisting of F, Cl, and a C₁-C₃ perfluoroalkyl group.

20) The composition according to claim 19, wherein repeating units —R_{f}³—O— are selected from the group consisting of:
(a2) units —CF₂CF(Gₓ)O—
(b2) units —CF(Gₓ)O—
(c2) units —CF₂(CF₂)ₓ₁CF(Gₓ)(CF₂)ₓ₂O—, with X₁ and X₂ being zero or integers from 1 to 2, with the provision that X₁+X₂ is at least 1, wherein:
Gₓ is a C₁-C₅ perfluoro(oxy)alkylene group comprising at least one nitrile group.

21) The composition according to claim 18, wherein the compound (CN-PFPE) has formula (III):
T^{B}-O—R_{f}⁴-T^{B′} (III)
wherein:
R_{f}⁴ is a (per)fluoropolyether backbone chain [chain (R_{f}⁴)], and
T^{B} and T^{B′}, equal to or different from each other, are (hydro)(fluoro)carbon groups, optionally comprising ethereal oxygen atom(s), and comprising at least one nitrile group at a terminal position or at a position adjacent to said terminal position.

22) The composition according to claim 21, wherein T^{B} and T^{B′} are groups of formula —CFZ*—CN, wherein Z* is F or CF₃.

23) The composition according to claim 21, wherein:
said chain (R_{f}⁴) comprises repeating units independently selected from the group consisting of:
(i) —CFXO—, wherein X is F or CF₃;
(ii) —CFXCFXO—, wherein X, equal or different at each occurrence, is F or CF₃, with the proviso that at least one of X is F;
(iii) —CF₂CF₂CW₂O—, wherein each of W, equal or different from each other, are F, Cl, H;
(iv) —CF₂CF₂CF₂CF₂O—;
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of X being independently F or CF₃ and T being a C₁-C₃ perfluoroalkyl group, and
said chain (R_{f}⁴).

24) The composition according to claim 16, wherein the amount of compound (AP) in composition (C) ranges from 0.2 to 50% (wt).

25) The composition according to claim 16, wherein the amount of compound (CN-PFPE) in composition (C) ranges from 50 to 99.8% (wt).

26) A process for the manufacture of a (per)fluoropolyether-based thermoset, comprising:
a) mixing at least one (per)fluoropolyether compound comprising a plurality of nitrile groups [compound (CN-PFPE)] with at least one bis-amino(thio)phenol compound [compound (AP)] of formula: 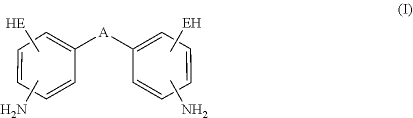
thus obtaining a (per)fluoroelastomer composition [composition (C)],
wherein:
A is selected among: —SO₂—, —O—, —C(O)—, divalent hydrocarbon groups of 1 to 10 carbon atoms;
each of E, equal or different at each occurrence, is oxygen or sulphur,
—NH₂ groups and EH groups are interchangeably in ortho, meta or para positions with respect to the group A, and
—NH₂ groups are in ortho with respect to EH groups.
b) heating said composition (C) to a temperature of at least 30° C., so as to obtain the (per)fluoropolyether-based thermoset.

27) The process according to claim 26, comprising mixing a compound (CN-PFPE) of formula (III):
T^{B}-O—R_{f}⁴-T^{B′} (III)
wherein:
R_{f}⁴ is a (per)fluoropolyether backbone chain, and T^{B} and T^{B′} are groups —CF₂—CN, with 2,2-bis(3-amino-4-hydroxyphenyl)hexafluoropropane as compound (AP).

28) The process according to claim 26, wherein said step b) comprises heating said composition (C) to a temperature ranging from 30 to 300° C.

29) The process according to claim 28, wherein said step b) comprises heating said composition (C) for a time ranging from 0.1 to 200 hours.

30) A (per)fluoropolyether-based thermoset obtained with the process according to claim 26.
